(19) United States
(12) Patent Application Publication
(10) Pub. No.: US 2025/0016678 A1
(43) Pub. Date: Jan. 9, 2025

(54) NETWORK ENERGY CONSUMPTION MANAGEMENT SYSTEM AND METHOD, AND STORAGE MEDIUM

(71) Applicant: NTT DOCOMO, INC., Tokyo (JP)

(72) Inventors: Liu Liu, Beijing (CN); Xufei Zheng, Beijing (CN); Jing Wang, Beijing (CN); Yu Jiang, Beijing (CN); Lan Chen, Beijing (CN)

(73) Assignee: NTT DOCOMO, INC., Tokyo (JP)

(21) Appl. No.: 18/710,530

(22) PCT Filed: Nov. 16, 2021
(86) PCT No.: PCT/CN2021/130921

§ 371 Date: May 15, 2024

(51) Int. Cl. H04W 52/02

(52) U.S. Cl. CPC H04W 52/0232; H04W 52/0251

(57) ABSTRACT

The present application provides a network energy consumption management system, including: a training unit, which is configured to acquire training data from at least one network node, and use the training data to train an energy consumption management model, so as to obtain a trained energy consumption management model; a prediction unit, which is configured to acquire input data from the at least one network node, and provide the input data for the trained energy consumption management model, so as to obtain output decision data; and an execution unit, which is configured to control the at least one network node to execute an energy conservation operation on the basis of the decision data.

### TECHNICAL FIELD

The present disclosure relates to the field of wireless network energy saving, in particular to a network energy consumption management system, method and storage medium based on artificial intelligence algorithm.

### BACKGROUND

In recent years, with the development of industrial Internet, the energy consumption of wireless networks has increased year by year. According to statistics, China Mobile's total energy consumption in 2020 is 29.23 billion kWh, of which the energy consumption of the wireless network is about 19 billion kWh, accounting for as much as 65%. The energy consumption of the base station is the most dominant part of the wireless network energy consumption, from 2011 to 2020, China Mobile's total energy consumption average annual growth is 9.69%, the average annual growth of energy consumption of the base station is as high as 10.89%. Compared with the previous generation of base stations, 5G base station equipment has high transmit power and a large number of channels, and the energy consumption of a single station is 3 to 4 times that of a 4G base station, making the need for more efficient energy-saving technologies even more urgent.

Existing energy management techniques for wireless networks are usually static, manual base station switching techniques at the network level, or carrier/time slot/channel/symbol switching techniques at the station level. Such traditional techniques cannot adapt to the dynamic changes in wireless network services, which can degrade the quality of service and user experience.

Introducing Artificial Intelligence (AI) algorithms into wireless networks in order to predict services, loads, and user movements, and to fine-tune and dynamically customize power-saving strategies based on the predictions has been a hot research topic in recent years. However, if AI algorithms are to be introduced to manage the energy consumption of a wireless network, signaling interactions within the station (e.g., between the central unit (CU) and the distribution unit (DU)) or between the stations are required, but the relevant signaling is not yet supported in the current standards.

### SUMMARY

The present disclosure has been made in view of the above problems. An object of the present disclosure is to provide a network energy consumption management system, method and storage medium based on artificial intelligence algorithm, wherein a plurality of deployment architectures for AI models are proposed, and in each deployment architecture, data required for training/updating, predicting, and executing the AI models is defined, as well as the impact on the wireless network interface in order to transmit such data.

In one exemplary aspect, the present disclosure provides a network energy consumption management system, comprising: a training unit configured to acquire training data from at least one network node and train an energy consumption management model using the training data to obtain a trained energy consumption management model; a prediction unit configured to obtain input data from the at least one network node and provide the input data to the trained energy consumption management model to obtain output strategy data, and an execution unit configured to control the at least one network node to perform an energy saving operation based on the strategy data.

In some embodiments, the network energy consumption management system further comprises an administrative unit configured to maintain and manage the at least one network node, and wherein the target network node of the at least one network node subjected to energy consumption management comprises a central unit and a distribution unit.

In some embodiments, the training unit and the prediction unit are arranged in the administrative unit.

In some embodiments, the training unit is arranged in the administrative unit and the prediction unit is arranged in a central unit of the target network node.

In some embodiments, the training unit and the prediction unit are arranged in a central unit of the target network node.

In some embodiments, the training unit sends a training data request to the at least one network node via a first interface between the administrative unit and the at least one network node. The at least one network node sends the training data to the training unit via the first interface in response to the training data request.

In some embodiments, the training unit sends a training data request to another network node over a second interface between the target network node and the other network nodes. The other network node sends the training data to the training unit via the second interface in response to the training data request.

In some embodiments, the prediction unit sends an input data request to the at least one network node via a first interface between the administrative unit and the at least one network node. The at least one network node sends the input data to the prediction unit via the first interface in response to the input data request.

In some embodiments, the prediction unit sends an input data request to another network node via a second interface between the target network node and the other network node. The other network node sends the training data to the prediction unit via the second interface in response to the input data request.

In some embodiments, the prediction unit further sends an energy consumption management model request to the administrative unit via a first interface between the administrative unit and the target network node. The administrative unit sends the trained energy consumption management model to the prediction unit via the first interface in response to the energy consumption management model request.

In some embodiments, upon receiving the strategy data, the prediction unit sends the strategy data to the target network node over a first interface between the administrative unit and the target network node.

In some embodiments, the network energy consumption management system further comprises a model updating unit configured to acquire feedback data from the at least one network node in response to an update request and to send the feedback data to the training unit, causing the training unit to update the energy consumption management model based on the feedback data.

In some embodiments, the training data or the input data is obtained from the at least one network node based on one of: a) by sending request signaling; b) at a predetermined periodicity; and c) by sending request signaling at a predetermined periodicity.

In some embodiments, the feedback data is obtained from the at least one network node based on one of: a) by sending request signaling; b) at a predetermined periodicity; and c) by sending request signaling at a predetermined periodicity.

In some embodiments, the training data or the input data comprises one or more of traffic load, resource status, energy consumption, movement track prediction, movement history information of the at least one network node.

In some embodiments, the strategy data comprises one or more of shutting down a device, shutting down a channel, switching a node, and timing startup.

In some embodiments, the feedback data comprises one or more of load measurement data, virtual storage usage data, energy consumption and quality of user service of the at least one network node.

In some embodiments, the performing unit is further configured to control the at least one network node to stop performing the energy saving operation in response to a certain event or a certain timing.

In another exemplary aspect, the present disclosure also provides a network energy consumption management method. The method comprises: acquiring training data from at least one network node and training an energy consumption management model using the training data to obtain a trained energy consumption management model; obtaining input data from the at least one network node and providing the input data to the trained energy consumption management model to obtain output strategy data; and controlling the at least one network node to perform an energy saving operation based on the strategy data.

In another exemplary aspect, the present disclosure also provides a non-transitory computer-readable storage medium having instructions stored thereon that, when executed by a processor, the instructions cause the processor to: acquire training data from at least one network node and training an energy consumption management model using the training data to obtain a trained energy consumption management model; obtain input data from the at least one network node and providing the input data to the trained energy consumption management model to obtain output strategy data; and control the at least one network node to perform an energy saving operation based on the strategy data.

### BRIEF DESCRIPTION OF DRAWINGS

FIG. 1 illustrates a schematic diagram of a network energy consumption management system in accordance with an embodiment of the principles of the present disclosure.

FIG. 2 illustrates a schematic diagram of an example of a deployment architecture for an energy consumption management model in a network energy consumption management system, in accordance with an embodiment of the principles of the present disclosure.

FIG. 3 illustrates a schematic diagram of another example of a deployment architecture of an energy consumption management model in a network energy consumption management system, in accordance with an embodiment of the principles of the present disclosure.

FIG. 4 illustrates a schematic diagram of yet another example of a deployment architecture for an energy consumption management model in a network energy consumption management system, in accordance with an embodiment of the principles of the present disclosure.

FIG. 5 illustrates an example flow diagram of an energy consumption management process in a network energy consumption management system, in accordance with an embodiment of the principles of the present disclosure.

FIG. 6 illustrates another example flow diagram of an energy consumption management process in a network energy consumption management system, in accordance with an embodiment of the principles of the present disclosure.

FIG. 7 illustrates yet another example flow diagram of an energy consumption management process in a network energy consumption management system, in accordance with an embodiment of the principles of the present disclosure.

FIG. 8 illustrates yet another example flow diagram of an energy consumption management process in a network energy consumption management system, in accordance with an embodiment of the principles of the present disclosure.

FIG. 9 shows a schematic diagram of functional modules of an energy consumption management model in a network energy consumption management system in accordance with an embodiment of the principles of the present disclosure.

FIG. 10 shows an example flow diagram of a network energy consumption management method in accordance with an embodiment of the principles of the present disclosure.

FIG. 11 illustrates a schematic diagram of a computer readable storage medium in accordance with an embodiment of the principles of the present disclosure.

### DETAILED DESCRIPTION

Embodiments of the present disclosure will be described in more detail below with reference to the accompanying drawings. While some embodiments of the present disclosure are illustrated in the accompanying drawings, it is to be understood that the present disclosure may be embodied in various forms and should not be construed as limited to the embodiments set forth herein, but rather, these embodiments are provided for a more thorough and complete understanding of the disclosure. It should be understood that the drawings and examples of the present disclosure are for exemplary purposes only and are not intended to limit the scope of the present disclosure.

It should be understood that the various steps recited in the method implementation of the present disclosure may be executed in a different order, and/or in parallel. Additionally, method embodiments may include additional steps and/or omit certain steps. In addition, each element or component described in the embodiments of the present disclosure may be implemented in the form of software, hardware, or a combination thereof, and each element or component may be integrated in the same chip, circuit board, or device.

As used herein, the term “include” and variations thereof are open inclusion, that is, “including, but not limited to”. The term “based on” means “based at least in part on.” The term “an embodiment” means “at least one embodiment”, the term “another embodiment” means “at least one additional embodiment”; the term “some embodiments” means “at least some embodiments”. Relevant definitions for other terms will be given in the description below.

It should be understood that the concept of “first”, “second” and the like mentioned in the present disclosure is only used to distinguish different apparatus, modules or units, and is not used to limit the order or interdependence of the functions performed by these apparatus, modules or units.

It is noted that the modifiers referred to in the present disclosure as “a”, “a plurality” are illustrative rather than limiting, and those skilled in the art should understand that it should be understood as “one or more” unless the context clearly indicates otherwise.

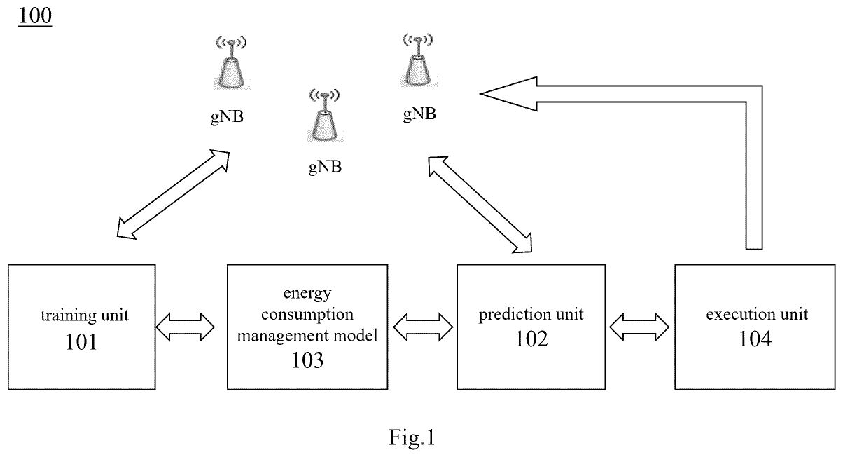

Embodiments of the present disclosure provide a network energy consumption management system. FIG. 1 illustrates a schematic diagram of a network energy consumption management system 100 in accordance with an embodiment of the principles of the present disclosure.

As shown in FIG. 1, the network energy consumption management system 100 includes at least a training unit 101, a prediction unit 102, and an execution unit 104. It should be understood that, the training unit, the prediction unit, and the execution unit mentioned in this embodiment should all be taken as functional units or modules, and does not mean that the above units are all implemented in the form of mutually independent hardware entities. Indeed, the training unit, the prediction unit and the execution unit may be deployed in any possible way, e.g. both the training unit and the prediction unit are deployed in a network management module, while the execution unit is deployed in a respective network node. Alternatively, the training unit, the prediction unit and the execution unit may all be deployed in the same network node at the same time. The manner of deployment of the above respective functional modules is not limited to the manner described above, and possible deployment architectures will be described in detail later.

The network energy consumption management system 100 of the present disclosure introduces an Artificial Intelligence (AI) algorithm model to make predictions of each network node's traffic, load, user movement, etc., and develop power saving strategies based on the results of the predictions. The artificial intelligence (AI) algorithm models introduced in the network energy consumption management system 100 are collectively referred to herein as “energy consumption management models,” i.e., energy consumption management model 103 as shown in FIG. 1.

In some embodiments, the energy consumption management model 103 may be implemented by a neural network, such as a convolutional neural network CNN or a recurrent neural network RNN. For example, the energy consumption management model 103 may include an input layer, a hidden layer, and an output layer, wherein the input layer is used to receive input data for energy consumption management, on the hidden layer there are “neurons” which operate by means of activation functions, and strategy data for energy consumption management are output on the output layer after computation by the neurons.

In order to enable the energy consumption management model 103 to output effective energy management strategy data based on input data, it is first necessary to train the energy consumption management model 103. The general method for training the energy consumption management model 103 is to input enough sample data into the model, adjust the network parameters (mainly adjusting the weight values) through certain algorithms, and make the network output match the expected value.

As shown in FIG. 1, the training unit 101 is configured to control the training of an energy consumption management model 103. In some embodiments, the training unit 101 is configured to acquire training data from at least one network node (e.g., a plurality of 5G base station, gNB, as shown in FIG. 1, or a user equipment, UE, (not shown)) and train the energy consumption management model 103 using said training data to obtain a trained energy consumption management model 103.

In some embodiments, the training data may comprise, for example, one or more of traffic load, resource status, energy consumption, movement trajectory prediction, movement history information of the at least one network node.

For example, the training data may include a historical traffic load, a current traffic load, and a predicted traffic load of a target base station for which energy consumption management is required. Furthermore, the training data may further include historical traffic loads, current traffic loads, and predicted traffic loads of user equipment served by the target base station described above. In addition, when considering the needs of the handover strategy of the energy consumption management model 103, the training data may further include a current traffic load and a predicted traffic load of a neighboring base station of the above-mentioned target base station, and a current traffic load and a predicted traffic load of a user equipment served by the above-mentioned neighboring base station. For the predicted traffic load as described above, an accuracy level corresponding to the predicted traffic load needs to be provided to the training unit 101 together in order to develop a more precise energy consumption management strategy.

In addition to traffic load related data as described above, the training data may also include historical resource status, current resource status, and predicted resource status for a target base station for which energy consumption management is required. Furthermore, the training data may also include historical resource status, current resource status, and predicted resource status of user equipment served by the target base station described above. Similarly, when considering the needs of the handover strategy of the energy consumption management model 103, the training data can also include current resource status and predicted resource status of neighboring base stations of the above-mentioned target base station, as well as the current resource status and predicted resource status of user equipment served by the above-mentioned neighboring base stations. For a predicted resource status as described above, an accuracy level corresponding to the predicted resource status needs to be provided to the training unit 101 together in order to make a more precise energy consumption management strategy.

Further, for example, the training data may also include a current energy consumption of the above-mentioned target base station, a predicted energy consumption of a neighboring base station adjacent to the target base station, and the like. Likewise, for the predicted energy consumption as described above, an accuracy level corresponding to the predicted energy consumption needs to be provided to the training unit 101 together in order to make a more precise energy consumption management strategy.

Further, for example, the training data may also include movement track predictions, movement history information, etc. of user equipment served by the target base station and its neighboring base station.

Further, other information that may be used as training data includes, but is not limited to, ID, location, carrier, voltage, temperature, humidity, storage usage of the target base station and its neighboring base station, UE measurement reports (e.g., RSRP, RSRQ, SINR reports) of the target base station and its neighboring base station, real-time information of number of users of the target base station and its neighboring base station, timestamps of requiring energy consumption strategies of the target base station and its neighboring base station, energy saving scenarios of the target base station and its neighboring base station, UE historical traffic information (e.g., traffic patterns, uplink/downlink traffic volume) of the target base station and its neighboring base station, etc.

In addition, UE request information or willingness information fed back by the user equipment itself may also be used as training data, such as the remaining power of the terminal, willingness of the intensity of the desired power saving, and the like. For example, if the user carries a rechargeable battery with him, the willingness information of prioritizing performance may be fed back. In contrast, if the user does not carry a rechargeable battery with him, the willingness information of prioritizing power saving may be fed back.

The training unit 101 may acquire training data as described above from at least one network node in various ways. In some embodiments, training unit 101 may acquire training data by sending request signaling. For example, the training unit 101 may send corresponding request signaling to a target base station requiring energy consumption management, its neighboring base station, and user equipment served by the target base station and the neighboring base station via a predetermined interface to obtain training data such as traffic load, resource status, energy consumption, movement track prediction, movement history information of the above-mentioned at least one network node.

Alternatively, the training unit 101 may also automatically acquire the above-mentioned training data at a predetermined period or frequency. For example, the training data may be automatically acquired at a frequency of once per minute.

In addition, the training unit 101 may also combine the above two ways to acquire training data. For example, request signaling may be sent periodically to trigger information needed for power saving strategies, thereby acquiring data needed for training from individual network nodes.

After the training unit 101 acquires data required for training in the manner as described above and completes training of the energy consumption management model 103 using the above-described training data, a trained energy consumption management model 103 can be obtained, which can be used to predict and develop strategies on the energy consumption of the respective network nodes (e.g., base station) in an actual scenario, causing the respective network nodes to perform energy-saving operations, so that the energy consumption of the entire network is optimized.

In the present disclosure, predicting and making strategies about energy consumption of individual network nodes using the trained prediction unit energy consumption management model 103 is controlled by the prediction unit 102. Specifically, the prediction unit 102 as shown in FIG. 1 is configured to obtain input data from at least one network node and to provide said input data to the trained energy consumption management model 103 to obtain the output strategy data.

In the present disclosure, the input data acquired by the prediction unit 102 may be of the same or similar type as the training data described above.

For example, in some embodiments, the input data may comprise, for example, one or more of traffic load, resource status, energy consumption, movement track prediction, movement history information of the at least one network node.

For example, the input data may include a historical traffic load, a current traffic load, and a predicted traffic load of a target base station for which energy consumption management is required. In addition, the input data may further include historical traffic loads, current traffic loads, and predicted traffic loads of user equipment served by the above target base station. In addition, when considering the needs of the handover strategy of the energy consumption management model 103, the input data may also include the current traffic load and the predicted traffic load of the neighboring base stations of the above-mentioned target base station, as well as the current traffic load and the predicted traffic load of the user equipment served by the above-mentioned neighboring base stations. For the predicted traffic load as described above, an accuracy level corresponding to the predicted traffic load needs to be provided to the prediction unit 102 together in order to make a more precise energy consumption management strategy.

In addition to traffic load related data as described above, the input data may also include historical resource status, current resource status, and predicted resource status of a target base station for which energy consumption management is required. Furthermore, the input data may also include historical resource status, current resource status, and predicted resource status of user equipment served by the target base station described above. Similarly, when considering the needs of the handover strategy of the energy consumption management model 103, the input data may also include current and predicted resource status of neighboring base stations of the above-mentioned target base station, and current and predicted resource status of user equipment served by the above-mentioned neighboring base stations. For a predicted resource status as described above, a level of accuracy corresponding to the predicted resource status needs to be provided to the prediction unit 102 together in order to make a more precise energy consumption management strategy.

Further, for example, the input data may also include a current energy consumption of the above-mentioned target base station, a predicted energy consumption of a neighboring base station adjacent to the target base station, or the like. Likewise, for the predicted energy consumption as described above, an accuracy level corresponding to the predicted energy consumption needs to be provided to the prediction unit 102 together in order to make more precise energy consumption management strategies.

Further, for example, the input data may further include movement track predictions, movement history information, and the like of user equipment served by the above-described target base station and its neighboring base stations.

In addition, other information that can be used as input data includes, but is not limited to, ID, location, carrier, voltage, temperature, humidity, storage usage of the above target base station and its neighboring base stations, UE measurement reports (e.g., RSRP, RSRQ, SINR reports) of the above target base station and its neighboring base stations, real-time information of number of users of the above target base station and its neighboring base stations, timestamps for requiring energy consumption strategies of the target base station and its neighboring base stations, energy saving scenarios of the target base station and its neighboring base stations, UE historical traffic information (e.g., traffic patterns, uplink/downlink traffic volume) of the target base station and its neighboring base stations, etc.

In addition, UE request information or willingness information fed back by the user equipment itself may also be used as input data, such as the remaining power of the terminal, willingness of the intensity of the desired power saving, and the like. For example, if the user carries a rechargeable battery with him, a willingness information of prioritizing performance may be fed back. In contrast, if the user does not carry a rechargeable battery with him, a willingness information of prioritizing power saving may be fed back.

The prediction unit 102 may acquire the input data as described above from the at least one network node in various ways. In some embodiments, the prediction unit 102 may acquire the input data by sending request signaling. For example, the prediction unit 102 may send corresponding request signaling to a target base station requiring energy consumption management, its neighboring base stations, and user equipment served by the target base station and the neighboring base stations via predetermined interface, thereby obtaining input data such as traffic load, resource status, energy consumption, movement track prediction, movement history information of the above-mentioned at least one network node.

Alternatively, the prediction unit 102 may also automatically acquire the input data at a predetermined period or frequency. For example, the input data may be automatically acquired at a frequency of once per minute.

In addition, the prediction unit 102 may acquire the input data in combination with the above two approaches. For example, request signaling may be sent periodically to trigger information needed for power saving strategies, thereby acquiring data needed for training from individual network nodes.

After the prediction unit 102 acquires input data required for prediction in the manner as described above and provides the above input data to the trained energy consumption management model 103, the trained energy consumption management model 103 makes predictions and develops strategies on the energy consumption of respective network nodes (e.g., base station) based on the input data, thereby outputting strategy data that can be used for energy saving purposes.

In the present disclosure, the strategy data output by the trained energy consumption management model 103 includes one or more of shutting down a device, shutting down a channel, switching nodes, and timing startup.

For example, in some embodiments, the strategy data output by the trained energy consumption management model 103 can include energy saving strategy data at a network level, such as turning base station devices on or off, bringing base station devices into a sleeping status, or the like. Further, the strategy data may also include energy saving strategy data at the station level, e.g., shutting down or adjusting time/frequency/space/power domain (or new on/off pattern), channel shutdown, carrier shutdown, etc.

Furthermore, the strategy data output by the trained energy consumption management model 103 can also include handover strategy data, e.g., recommending a candidate node for the target energy saving node to take over its traffic.

In some embodiments, the strategy data output by the trained energy consumption management model 103 may further include one or more of the following: a recommended time period for a sleeping mode, a start-up time for an energy saving strategy, a valid time window for an energy saving strategy, an estimated energy consumption, an estimated accuracy for an energy saving strategy, and the like.

After the trained energy consumption management model 103 outputs the above-described strategy data, the execution unit 104 as described in FIG. 1 may perform energy saving operations for one or more network nodes based on the strategy data, thereby optimizing the energy consumption of the entire network.

An overall architecture of the energy consumption management system 100 provided by the present disclosure is described above based on FIG. 1. It should be appreciated that although separate descriptions are provided above for each functional module separately, this is merely for ease of understanding and does not imply that the training unit 101, the prediction unit 102, the energy consumption management model 103 and the execution unit 104 as described above are necessarily deployed independently of each other. In fact, depending on the needs of the scenario, one or more of the above functional units may be integrated and deployed in the same device, or they may be deployed separately in different devices.

In the 3GPP 5G system architecture, the management work of the network is usually divided into three major categories: operation, administration and maintenance, or referred to as OAM. Operation is mainly to complete the analysis, prediction, planning and configuration of the daily network and services, and maintenance is mainly the daily operation of the network and its services, such as testing and fault management, etc. When 5G is deployed independently, based on the configuration of the protocol stack functions, the gNB's logical system adopts the CU (i.e., central unit) and DU (distribution unit) separation mode or combination mode. In the CU-DU separation architecture, the functions of the NR protocol stack can be dynamically configured and segmented, with some of the functions realized in the CU and the remaining functions realized in the DU. To fulfill the requests of different segmentation options, both ideal and non-ideal transport networks need to be supported. The interface between the CU and the DU should follow the 3GPP specification requests. In the CU-DU combined architecture, the logical functions of the CU and the DU are integrated in the same gNB, and this gNB realizes all the functions of the protocol stack.

In addition, global operators, driven by the O-RAN Alliance, are pushing for the adoption of open RAN for 5G. The O-RAN Alliance defines a 5G RAN architecture that breaks down the once single-vendor, hardware-centric RAN into components, with interoperable standards precisely defining the interfaces between the components. The O-RAN Alliance proposes a model that breaks down the gNB into 3 specific component models: The Central Unit (O-CU) that handles the upper layer protocols, the Distributed Unit (O-DU) and the Radio Unit (O-RU). In addition, O-RAN extends these standard network elements openly to support their intelligent management through Service Management and Orchestration (SMO). SMO is functionally equivalent to the network operation and management subsystem OAM or NMS, i.e., network management, of the traditional closed RAN access network equipment. SMO includes the following functionalities: the operation, maintenance, and administration of the cloud infrastructure implementation, the operation, maintenance, and administration of the wireless access network, and acting as a non-real-time RAN intelligent controller (Non RT RIC). In O-RAN, a new Radio Access Network-Non RT Control and Optimization interface (A1 interface) is added for SMO to control the wireless resources within O-RAN intelligently and dynamically at a fine-grained level.

It is noted that the network energy consumption management system described in the present disclosure may be deployed in both 3GPP standard architectures and O-RAN standard architectures, unless otherwise indicated in the text or unless it is obvious that it is not applicable according to the context.

In addition, although not shown in the accompanying drawings, the network energy consumption management system according to the present disclosure may also include an administrative unit configured to maintain and manage at least one network node in the network. For example, under the 3GPP standard architecture, the administrative unit may be an OAM that implements operation, administration, and maintenance functions as described above. In addition, in the O-RAN standard architecture, the administrative unit may be a Service Management and Orchestration (SMO) or a non-real-time RAN intelligent controller (Non RT RIC) as described above. Hereinafter, OAM, SMO, or Non RT RIC are collectively referred to as “administrative units”.

In addition, it should be understood that although it is shown above that the network node in the present disclosure may include a gNB or a UE, in actual design, the target network node for energy management or for performing energy-saving operations may include only the gNB, but not the user equipment served by the gNB. The reason why the user equipment is discussed above is mainly for the process of acquiring training data and input data, because the various state information of the user equipment being served by the gNB as input data will have an impact on the power saving strategy of the gNB itself. That is, the energy consumption management model described in the present disclosure develops power saving strategies for a target gNB by considering state information of the gNB itself, and state information of the user equipment served by the gNB, and also considering state information of neighboring gNBs and their served user equipment. In the case where a node of the gNB type is used as a target network node to be managed for energy consumption, the target network node may include a central unit (CU) and a distribution unit (CU), as described above. Under the 3GPP standard architecture, the central unit and the distribution unit may be a CU and a DU as described above. In the O-RAN standard architecture, the central unit and the distribution unit may be an O-CU and an O-DU as described above. In the following, the central unit and the distribution unit under both standard architectures are collectively referred to as the CU and the DU.

Additionally, under some deployment architectures, the network energy consumption management system of the present disclosure may also make node strategies for user devices. For example, as described above, when a user device provides UE request information or willingness information to a prediction unit, the network energy consumption management system in the present disclosure may also developing power saving strategies for the UE.

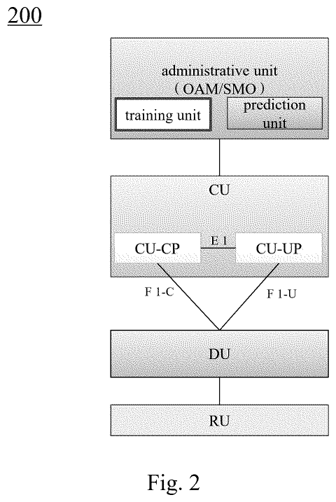

Different deployment architectures of the various functional modules in the energy consumption management system 100 of the present disclosure and their corresponding operational flows will be described below in connection with FIGS. 2-8.

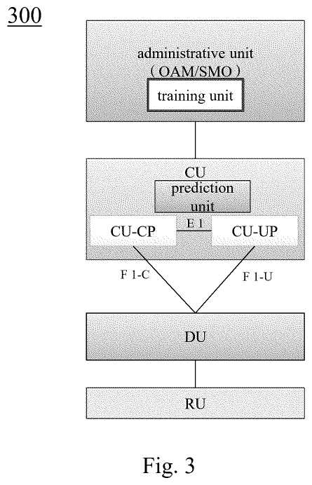

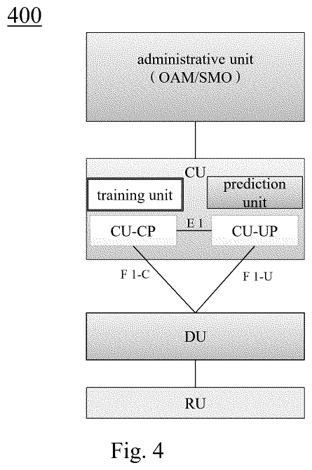

FIG. 2 illustrates a schematic diagram of an example of a deployment architecture 200 for an energy consumption management model in a network energy consumption management system, in accordance with an embodiment of the principles of the present disclosure. FIG. 3 illustrates a schematic diagram of an example of a deployment architecture 300 for an energy consumption management model in a network energy consumption management system, in accordance with an embodiment of the principles of the present disclosure. FIG. 4 illustrates a schematic diagram of an example of a deployment architecture 400 for an energy consumption management model in a network energy consumption management system, in accordance with an embodiment of the principles of the present disclosure.

FIG. 2 illustrates a deployment architecture 200 in which a training unit and a prediction unit are both deployed in an administrative unit of a network energy consumption management system.

As shown in FIG. 2, the training unit and the prediction unit are deployed simultaneously in an administrative unit (OAM or SMO). The main function of the E1 interface is to provide the interconnection between the CU-CP and the CU-UP of the gNB-CU of the NG-RAN. The F1 interface supports signaling exchange and data transmission between gNB-CU and gNB-DU, separation of radio network layer and transport network layer, exchange of user terminal related information or non-user terminal related information. In addition, the functions of the F1 interface are divided into F1-C (control plane) functions and F1-U (user plane) functions, providing interconnection between DU and CU-CP, DU and CU-UP, respectively.

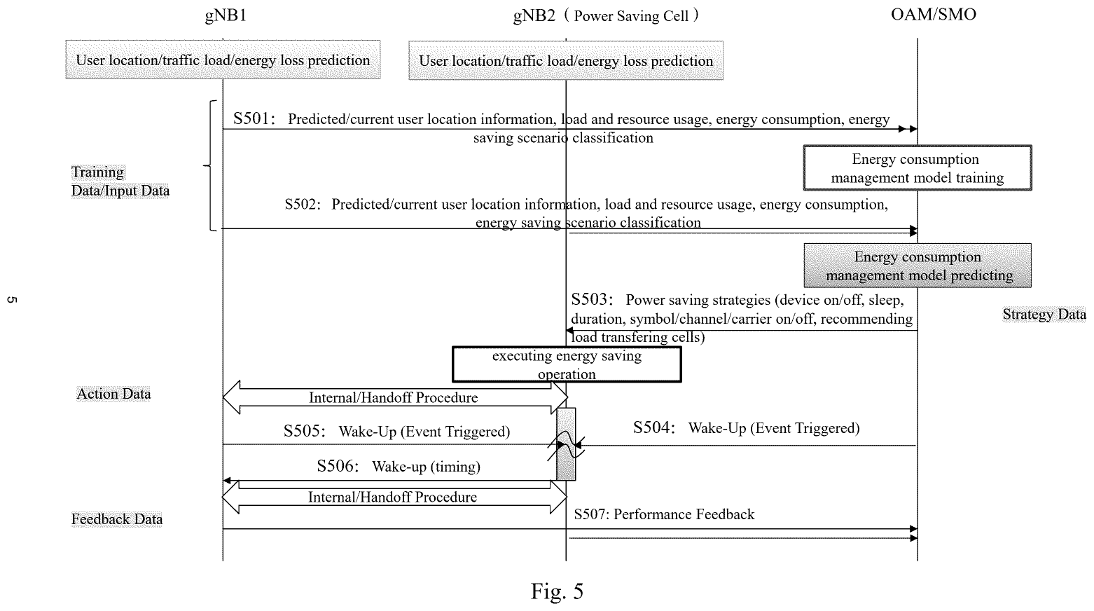

In the case where the energy consumption management model in the network energy consumption management system has deployment architecture 200, an example flow diagram of the energy consumption management process is shown in FIG. 5. In the example shown in FIG. 5, it is assumed that gNB2 is the target node to be power-saved, and gNB1 is its neighboring node. It should be understood that only one neighboring node gNB1 is shown in FIG. 5 for convenience of description and not limitation, in an actual situation, the number of neighboring nodes of the target node is not limited to one and the type is also not limited to a gNB. In addition, the training data and the input data may also be obtained from the user equipment served by the target node and the neighboring nodes, which has been described in detail above and will not be repeated here.

Since the training unit is deployed in the administrative unit, as shown in FIG. 5, in the training phase, the training unit needs to acquire training data from gNB1 and gNB2 (as shown in S501). The training data includes predicted/current user location information, load and resource usage, energy consumption, energy saving scenario classification, and the like, which are not repeated herein.

In some embodiments, the operation that the training unit needs to acquire training data from gNB1 and gNB2 needs to be triggered by the training unit sending request signaling to gNB1 and gNB2. For example, a training unit located in the administrative unit sends training data requests to gNB1 and gNB2 via a first interface between the administrative unit and gNB1/gNB2 (e.g., the A1 interface as described above), and in response to the training data requests, gNB1 and gNB2 send training data to the training unit via the first interface.

Optionally, the training unit may also automatically acquire the above-mentioned training data from gNB1 and gNB2 at a predetermined period or frequency. For example, the training data may be automatically acquired at a frequency of once per minute.

In addition, the training unit may also combine the two ways described above to acquire training data from gNB1 and gNB2. For example, request signaling may be sent periodically to trigger information needed for power saving strategies, thereby acquiring data needed for training from individual network nodes.

After the training unit trains the energy consumption management model with the acquired training data, the prediction unit deployed in the administrative unit may directly call the trained energy consumption management model in order to predict the energy consumption of the target node gNB2, thereby outputting strategy data. The prediction of the trained energy consumption management model is also dependent on the input data (acquired in S502) from gNB1 and gNB2, the type of the input data being similar to the type of the training data, which is not repeated here.

In some embodiments, the operation of the prediction unit to obtain input data from gNB1 and gNB2 needs to be triggered by the prediction unit sending request signaling to gNB1 and gNB2. For example, the prediction unit located in the administrative unit sends an input data request to gNB1 and gNB2 via a first interface between the administrative unit and gNB1/gNB2 (e.g., the A1 interface as described above), and in response to an input data request, gNB1 and gNB2 send input data to the prediction unit via the first interface.

Alternatively, the prediction unit may also automatically acquire the above input data from gNB1 and gNB2 at a predetermined period or frequency. For example, the input data may be automatically acquired at a frequency of once per minute.

In addition, the prediction unit may also combine the two approaches described above to obtain input data from gNB1 and gNB2. For example, request signaling may be sent periodically to trigger information needed from the various network nodes for power saving strategies to acquire data needed for prediction.

When the energy consumption management model outputs the strategy data based on the input data, the prediction unit controls to send the power-saving strategy data to the target node gNB2 (S503), so that the execution unit can perform the energy-saving operation according to the strategy data, thereby reducing the energy consumption of the target node gNB2.

In the architecture 200, since the prediction unit is deployed in the administrative unit, and the strategy data is also generated in the administrative unit, but the processing that actually needs to perform the power-saving operation using the strategy data is performed in the target node gNB2, therefore, the strategy data needs to be transmitted to the target node gNB2 via the interface between the administrative unit and the target node gNB2.

Sending the strategy data may be instantaneous, i.e. sent immediately after the prediction unit obtains the strategy data. Alternatively, the sending of the strategy data may also be triggered by a specific event, such as the energy consumption of the target node gNB2 exceeding a certain threshold, or the current traffic load of gNB2 exceeding a certain threshold, etc.

In the present disclosure, the strategy data may include energy saving strategy data at the network level, such as turning on or off the base station device, bringing the base station device into a sleeping status, and the like, and may also include energy saving strategy data at the station level, such as turning off or adjusting at the symbol/channel/carrier level, and the like. The output strategy data may also comprise handover strategy data, e.g. cells for load transferring after recommending candidate nodes to take over the services of the target energy saving node. In addition, the strategy data may also include a recommended time period for the sleeping mode, a start-up time for the energy saving strategy, a duration, and the like.

For example, where the strategy data comprises handover strategy data, a traffic handover may be performed between gNB1 and gNB2, such that gNB1 carries part or all of the traffic of the target node gNB2.

For example, in the case where the strategy data includes sleeping strategy data, the target node gNB2 may enter into a sleeping mode. After the target node gNB2 is in the energy saving status, the administrative unit may wake up the target node gNB2 in the energy saving status based on strategy data (e.g., duration, etc.) or other events (S504), or may send a wake-up event to gNB2 by the node gNB1 who is carrying its traffic (S505), thereby causing gNB2 in the energy saving status to end the energy saving status. In addition, the node gNB1 taking over its traffic may also be notified by the target node gNB2 of the wake-up timing data in the strategy data (S506), so that it can revert to a non-energy-saving status on its own after the end of this timing.

In some embodiments, after the energy saving operation is ended, the node gNB1 and the target node gNB2 as shown in FIG. 5 may also feedback a performance receipt to the model updating unit located in the administrative unit (S507). When the model updating unit receives the feedback data, it may send it to the training unit, causing the training unit to update the energy consumption management model based on the feedback data. Accordingly, the energy consumption management system of the present disclosure is also capable of online updating, which allows it to continuously update the energy consumption management model after the energy management for each node has been completed, so that the prediction and strategy-making capability of the energy consumption management model can be further improved.

It should be understood that the above refers to a model updating unit for updating an energy consumption management model, and the model updating unit may be a stand-alone functional module independent of the training unit and the prediction unit, or may be an additional functional module of the training unit or the prediction unit. For example, the training unit may also have the function of the model updating unit, so that the training unit can be directly utilized to obtain feedback data and thus realize the updating of the model.

In some embodiments, the feedback data as described above comprises one or more of load measurement data, virtual storage usage data, energy consumption and quality of user service (QoS) of the at least one network node. For example, the feedback data as shown in FIG. 5 may include bandwidth usage, virtual storage usage, energy consumption, and user QoS (e.g., packet drop rate, latency, average rate, quantity of data transfer, etc.) of gNB1 and gNB2. In addition, the feedback data can also include other KPI information for gNB1 and gNB2, such as the number or ratio of failed/successful handovers, CQI/MCS distribution, SS-RSRP distribution, etc.

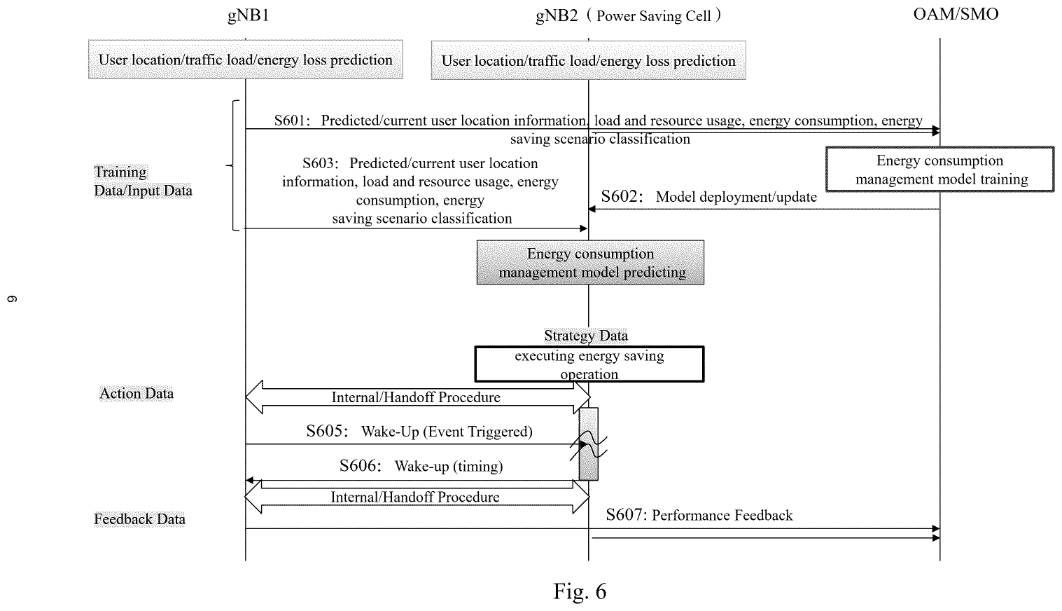

The above, in conjunction with FIGS. 2 and 5, describes the deployment architecture and energy management process where both the training unit and the prediction unit are deployed in the administrative unit. The model architecture and energy management process where the training unit deployed in the administrative unit and the prediction unit deployed in the CU of the gNB is described below in conjunction with FIGS. 3 and 6.

FIG. 3 illustrates a deployment architecture 300 in which training units are deployed in an administrative unit in a network energy consumption management system, and prediction units are deployed in a CU of a target node.

The description of the various functional modules and interfaces in FIG. 3 is similar to FIG. 2 and will not be repeated here. Compared to deployment architecture 200 in FIG. 2, deployment architecture 300 differs in that the prediction unit is transferred to the CU of the target node.

In the case where the energy consumption management model in the network energy consumption management system has deployment architecture 300, an example flow diagram of the energy consumption management process is shown in FIG. 6. In the example shown in FIG. 6, it is also assumed that gNB2 is the target node to be power-saved, and gNB1 is its neighboring node. It should be understood that only one neighboring node gNB 1 is shown in FIG. 6 for convenience of description and not limitation, in an actual situation, the number of neighboring nodes of the target node is not limited to one and the type is also not limited to gNB. In addition, the training data and the input data may also be obtained from the user equipment served by the target node and the neighboring nodes, which has been described in detail above and will not be repeated here.

Since the training unit is deployed in the administrative unit, as shown in FIG. 6, in the training phase, the training unit needs to acquire training data from gNB1 and gNB2 (as shown in S601). The training data includes predicted/current user location information, load and resource usage, energy consumption, energy saving scenario classification, and the like, which are not repeated herein.

In some embodiments, the operation that the training unit needs to acquire training data from gNB1 and gNB2 needs to be triggered by the training unit sending request signaling to gNB1 and gNB2. For example, the training unit located in the administrative unit sends training data requests to gNB1 and gNB2 via a first interface between the administrative unit and gNB1/gNB2 (e.g., the A1 interface as described above), and in response to the training data requests, gNB1 and gNB2 send training data to the training unit via the first interface.

Optionally, the training unit may also automatically acquire the above-mentioned training data from gNB1 and gNB2 at a predetermined period or frequency. For example, the training data may be automatically acquired at a frequency of once per minute.

In addition, the training unit may also combine the two ways described above to acquire training data from gNB1 and gNB2. For example, request signaling may be sent periodically to trigger information needed for power saving strategies, thereby acquiring data needed for training from individual network nodes.

After the training unit trains the energy consumption management model with the acquired training data, since the prediction unit is deployed not in the administrative unit as shown in FIG. 2, but in the CU of the target node gNB2, the prediction unit needs to obtain the trained energy consumption management model through the interface between the administrative unit and gNB2 (S602).

In some embodiments, the prediction unit sends an energy consumption management model request to the administrative unit via a first interface between the administrative unit and gNB2, and in response to the energy consumption management model request, the administrative unit sends a trained energy consumption management model to the prediction unit via the first interface, or sends an updated energy consumption management model to the prediction unit.

Alternatively, the prediction unit may also automatically acquire the above-mentioned energy consumption management model or acquire an updated energy consumption management model from the administrative unit at a predetermined period or frequency. For example, the above-described energy consumption management model may be automatically acquired or an updated energy consumption management model may be acquired at a frequency of once every 24 hours.

In addition, the prediction unit may also combine the above two ways to obtain the energy consumption management model from the administrative unit. For example, request signaling may be sent periodically to trigger deployment or updating of the energy consumption management model, thereby obtaining a trained energy consumption management model or an updated energy consumption management model from the administrative unit.

After the target node gNB2 obtains the trained energy consumption management model or the updated energy consumption management model from the administrative unit, the prediction unit may obtain input data from gNB1 through a second interface (e.g., Xn interface) between the target node gNB2 and the neighboring node gNB1 (S603), input the input data into the energy consumption management model to make a prediction, thereby obtaining strategy data, and then perform an energy saving operation based on the strategy data. However, it should be noted that since the prediction unit is deployed in the CU of the target node gNB2 in the deployment architecture 300, there is no longer a need to obtain the input data from the gNB2 via the interface between the base stations as shown in FIG. 5, and instead, the corresponding input data can be read directly from the relevant storage location of the gNB2, and the input data from the target node gNB2 is likewise used by the energy consumption management model for prediction and strategy making. Steps S605 to S607 described in FIG. 6 are similar to steps S505 to S507 in FIG. 5 and will not be repeated herein.

Furthermore, it should also be noted that since in the deployment architecture 300, the prediction unit is deployed in the CU of the target node and the strategy data is generated in the CU of the target node and not in the administrative unit as shown in the architecture 200, the wake-up processing from the administrative, as shown in step S504 of FIG. 5, is no longer needed in the corresponding processing flow of the architecture 300.

It should be understood that in the deployment architecture 300 shown in FIG. 3, by deploying the prediction unit in the target node gNB2, the step of transmitting strategy data from the administrative unit to the target node as shown in step S503 of FIG. 5 can be omitted. But due to the separation of the training unit from the prediction unit, the step of deploying or transmitting the energy consumption management model to gNB2 (e.g., S602) is again added compared to the flow of FIG. 5. Thus, the deployment architecture 200 in FIG. 2 each has its different advantages and disadvantages compared to deployment architecture 300 in FIG. 3. The deployment architecture 200 in FIG. 2 centrally deploys both the training unit and the prediction unit in the administrative unit, and the training and prediction are uniformly performed by the administrative unit, which is advantageous for efficiently utilizing the computing capability of the administrative unit, the respective power-saving nodes only need to perform the power-saving operation based on the received strategy data and terminate the power-saving operation, the deployment manner is relatively simple, and the computing capability of the respective nodes is not occupied. In contrast, the deployment architecture 300 in FIG. 3 deploys the training unit and the prediction unit in the CU of the administrative unit and the node, respectively, advantageously balancing the computing tasks of the network node and the administrative unit, while not only avoiding the latency of the operation caused by the transmission of the data, but also effectively improving the security of the network because the transmission of the strategy data between the administrative unit and the power-saving node is avoided, but the manner of deployment thereof is relatively complicated.

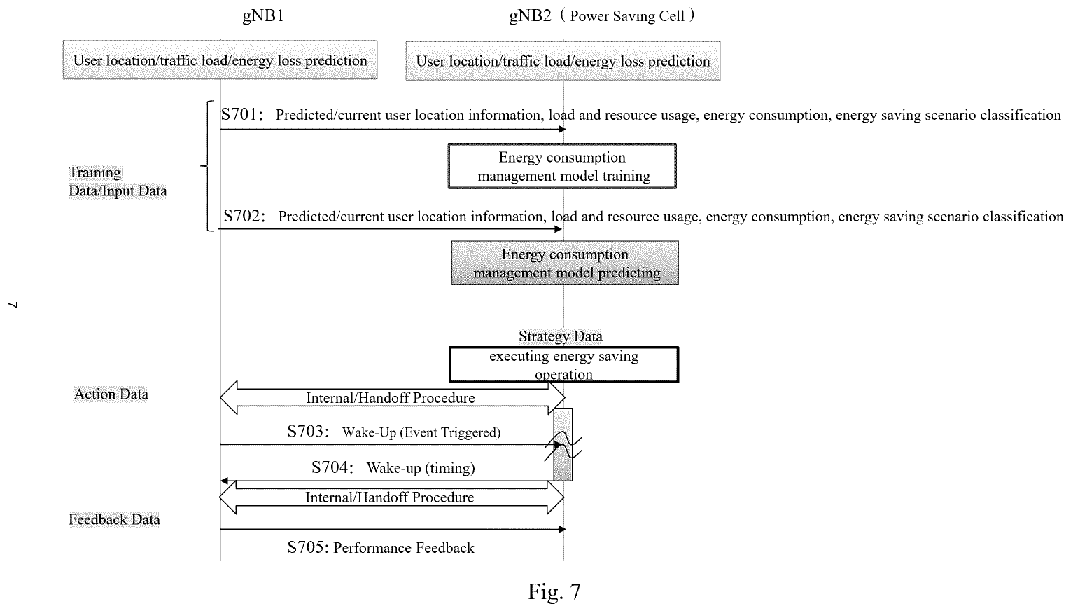

In addition to the above two deployment manners, the present disclosure proposes another more distributed and more flexible deployment method of the energy consumption management model. A model architecture and an energy consumption management flow that deploys both a training unit and a prediction unit in a CU of a target node will be described below in connection with FIGS. 4 and 7.

FIG. 4 illustrates a deployment architecture 400 that deploys both a training unit and a prediction unit in a CU of a target node.

The description of the various functional modules and interfaces in FIG. 4 is similar to that of FIGS. 2 and 3 and will not be repeated here. Compared to deployment architectures 200 and 300 in FIGS. 2 and 3, deployment architecture 400 differs in that both the training unit and the prediction unit are deployed in the CU of the target node.

In the case where the energy consumption management model in the network energy consumption management system has the deployment architecture 400, an example flow diagram of the energy consumption management process is shown in FIG. 7. In the example shown in FIG. 7, it is also assumed that gNB2 is the target node to be power-saved, and gNB1 is its neighboring node. It should be understood that only one neighboring node gNB 1 is shown in FIG. 7 for convenience of description and not limitation, in actual situations, the number of neighboring nodes of the target node is not limited to one and the type is also not limited to gNB. In addition, the training data and the input data may also be obtained from the user equipment served by the target node and the neighboring nodes, which has been described in detail above and will not be repeated here.

Since both the training unit and the prediction unit are deployed in the target node gNB2, as shown in FIG. 7, in the training phase, the training unit needs to acquire training data from gNB1 (as shown in S701). The training data includes predicted/current user location information, load and resource usage, energy consumption, energy saving scenario classification, and the like, which are not repeated herein.

In some embodiments, the operation that the training unit needs to acquire training data from gNB 1 needs to be triggered by the training unit by sending request signaling to the neighboring gNB 1. For example, a training unit located in a CU of target gNB2 sends a training data request to gNB1 via a second interface (e.g., an Xn interface) between gNB1 and gNB2, and in response to the training data request, gNB1 sends training data to the training unit via the second interface. Compared to the previous deployment architectures 200 and 300, the training unit from the target node gNB2 no longer needs to be obtained by sending request signaling and transmitting it between devices, instead, the training unit can read the corresponding training data directly from a storage location inside the target node gNB2.

Optionally, the training unit may also automatically acquire the above-mentioned training data from gNB1 at a predetermined period or frequency. For example, the training data may be automatically acquired at a frequency of once per minute.

In addition, the training unit may also combine the two ways described above to acquire training data from gNB1. For example, the request signaling may be sent periodically to trigger information needed for power saving strategies, thereby acquiring data needed for training from individual network nodes.

After the training unit trains the energy consumption management model with the acquired training data, since the prediction unit is not deployed separately from the training unit as shown in FIG. 3, there is no need to additionally transmit the trained energy consumption management model, but the trained energy consumption management model is directly obtained within the CU of the target node gNB2.

Afterwards, the prediction unit may acquire input data from gNB1 (S702) in a similar manner as in FIG. 6, and input the input data into the energy consumption management model to make a prediction, thereby obtaining strategy data, and then perform an energy saving operation based on the strategy data. Steps S703 and S704 described in FIG. 7 are similar to steps S505 and S506 in FIG. 5, respectively, and are not repeated here. Furthermore, it should be noted that since in the deployment architecture 400, the administrative unit is no longer involved in the training and prediction of the energy consumption management model, the performance feedback process as shown in step S705 sends the feedback data to the model updating unit located in the CU of the target node gNB2 via the above-mentioned second interface, instead of to the administrative unit as shown in FIGS. 5 and 6. Furthermore, it should also be noted that, since in the deployment architecture 400, the administrative unit is no longer involved in the training and prediction of the energy consumption management model, the wake-up process from the administrative unit as shown in step S504 of FIG. 5 is also no longer present in the corresponding process flow of the architecture 400.

The model architecture 400 that deploys both the training unit and the prediction unit in a CU of a target node and its energy consumption management process are described above in conjunction with FIGS. 4 and 7. Compared to previous deployment architectures 200 and 300, this architecture that deploys both the training unit and the prediction unit in the CU of the target node is more flexible due to the fact that it is no longer subject to unified management and training by the administrative unit. For example, each gNB with power saving needs can train its own energy consumption management model at the same time, and then each gNB can utilize its own energy consumption management model to implement energy consumption management for this node, thereby making energy consumption management more targeted and contributing to the improvement of the accuracy of energy consumption management.

A person skilled in the art may select any of the above three deployment architectures according to the application scenarios and the various capabilities of the network, and may also make various possible combinations as needed, thereby realizing the purpose of energy consumption management. Variations or combinations based on embodiments of the present disclosure also fall within the scope of protection of the present disclosure.

As described above, 5G base station functions are reconfigured as two functional entities, the CU and DU; the CU and DU functions are differentiated by the real-time nature of the processed content. The CU mainly consists of non-real-time wireless high-level stack functions, and also supports part of the core network function sink and the deployment of edge application services. The DU mainly handles the physical layer functions and real-time demanded functions. The CU and DU of a 5G base station can be deployed in various ways, for example, in a separated mode or a combined mode. In the CU-DU separation architecture, the functions of the NR protocol stack can be dynamically configured and segmented.

While the above describes different deployment architectures and processing flows for the network energy consumption management model in the present disclosure based on a base station in CU-DU combined mode, it does not imply that the above three architectures are applicable only to the CU-DU combined mode. In a CU-DU separated base station architecture, the above three deployment architectures are equally applicable.

In some embodiments, for CU-DU separated base station architectures, as functions related to real-time performance requirements of the base station are deployed in the DU, for the three different deployment architectures described above, additional data transfer steps are required to send training data and input data from the DU to the CU when training the energy consumption management model and when predicting using the trained energy consumption management model, and additional steps are also required to send the feedback data from the DU to the CU.

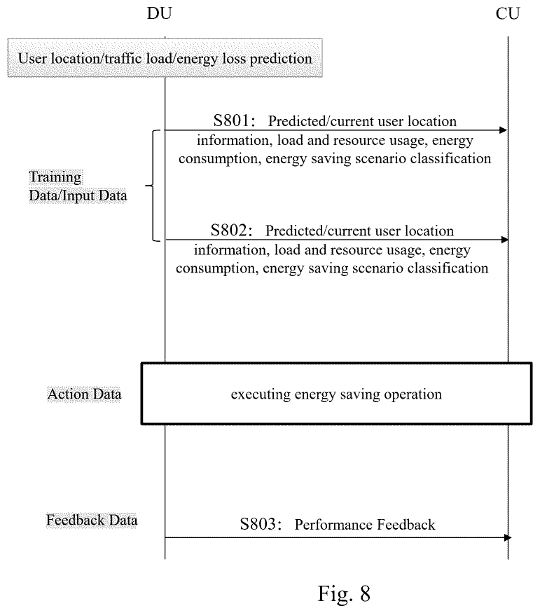

The flowchart shown in FIG. 8 illustrates additional flows applicable to the above three different training unit/prediction unit deployment architectures in a CU-DU separated base station architecture.

For example, since the CU and the DU of the base station are deployed separately, in the training phase, training data needs to be first sent from the DU to the CU via a specific interface (e.g., F1 interface) (S801), the training data in this step is similar to the training data shown in FIGS. 5-7, including predicted/current user location information, load and resource usage, energy consumption, energy saving scenario classification, etc. Similarly, in the prediction phase, input data also needs to be sent from the DU to the CU (S802) through a specific interface (e.g., F1 interface), and the input data in this step is also similar to those shown in FIGS. 5-7, which also including predicted/current user location information, load and resource usage, energy consumption, energy saving scenario classification, and the like.

In the case where the CU and the DU of the base station are separately deployed, when performing power saving operations, the CU configures the DU through the F1 interface to turn off part of the resources to save power, such as turning off part of the frequencies, antennas, transmission times, and the like. Further, performing the energy saving operation may further include recommending a time period of a sleeping mode, a startup time giving an energy saving strategy, a duration, and the like, to the DU.

Furthermore, after performing the energy saving operation, the DU sends feedback data to the CU via the above-mentioned specific interface (e.g., F1 interface), so that the CU further provides the feedback data to the model updating unit for updating the network energy consumption model.

It should be understood that in the CU-DU separated base station architecture, the acquisition or transmission of training data/input data/feedback data may likewise be based on the three ways described above, namely by transmitting request signaling, automatically acquired or transmitted at a predetermined frequency or periodicity, or acquired or transmitted in a hybrid manner (e.g., transmitting request signaling at a predetermined frequency or periodicity).

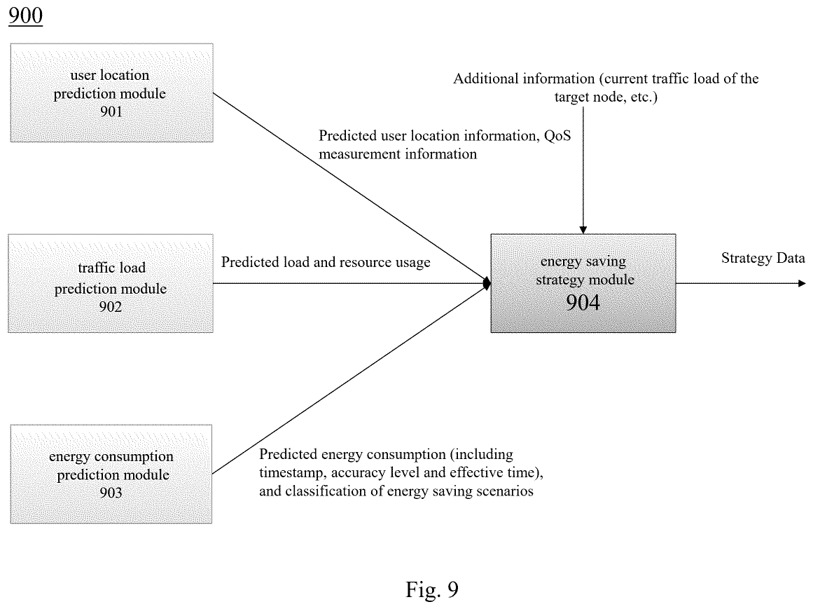

Various deployment mechanisms for the energy consumption management model and its data flow are described above in connection with the figures. As described above, the energy consumption management model of the present disclosure is a model based on an artificial intelligence algorithm, specifically, the energy consumption management model is implemented such as a convolutional neural network CNN or a recurrent neural network RNN. Functionally, the energy consumption management model in the present disclosure may include a prediction functional module and a strategy functional module. FIG. 9 shows a schematic diagram of functional modules of an energy consumption management model 900 in a network energy consumption management system in accordance with an embodiment of the principles of the present disclosure.

As shown in FIG. 9, the energy consumption management model 900 functionally includes a user location prediction module 901, a traffic load prediction module 902, an energy consumption prediction module 903, and an energy saving strategy module 904. The user location prediction module 901 is configured to predict user location information, QoS measurement information, and the like based on various types of input data as described above, the traffic load prediction module 902 is configured to predict traffic load and resource usage situation of the base station based on various types of input data as described above, and the energy consumption prediction module 903 is configured to predict energy consumption situation (including time stamp, accuracy level and validity time, and the like) and energy saving scenario classification. After the user location prediction module 901, the traffic load prediction module 902, and the energy consumption prediction module 903 obtain their respective prediction results, they are provided to the energy saving strategy module 904, which develops an energy saving strategy using the various prediction results as well as other input data (e.g., current traffic loads of the target node and neighboring nodes, etc.), and outputs strategy data.

The various prediction operations performed by the above-described user location prediction module 901, traffic load prediction module 902, and energy consumption prediction module 903 described above are likewise embodied in the flow diagrams of FIGS. 5-8. Taking FIG. 5 as an example, before sending training data to the training unit in step S501, user location/traffic load/energy loss predictions are first made in nodes gNB1 and gNB2, and then each node sends training data including the predicted user location/traffic load/energy loss data to the training unit. Similar operations are also illustrated in other flowcharts and will not be repeated here.

Various deployment architectures for the energy consumption management model and their data flows are described above in conjunction with the accompanying figures. As described above, a person skilled in the art may select any of the various deployment architectures based on the application scenarios and the various capabilities of the network, in order to adapt them to the various application scenarios and to be able to appropriately perform the energy consumption management.

It should be appreciated that while the above embodiments describe the energy consumption management system of the present disclosure with respect to only one target network node, this is only for ease of description. In practice, a person skilled in the art may deploy a similar energy consumption management model for a plurality of network nodes in a network, or even for each network node, as needed, so that the network energy consumption management system described in the present disclosure is able to manage the energy consumption of a plurality of network nodes, or of all the network nodes in the entire network, so as to achieve the goal of energy saving at the network level.

Furthermore, it should be understood that in the case of deploying a network model for a plurality of network nodes, it may not necessary to use the same deployment architecture for each network node. For example, for nodes with high computing capability of their own, an architecture that centralizes both training and prediction in the node itself may be adopted, thereby increasing the accuracy and flexibility of energy savings. Conversely, for nodes with limited computing capability, one may consider deploying training in the administrative unit, or deploying both training and prediction in the administrative unit, thereby making model deployment more convenient. The person skilled in the art may also take various combinations, or based on other needs or metrics, to flexibly deploy the above energy consumption management models throughout the network.

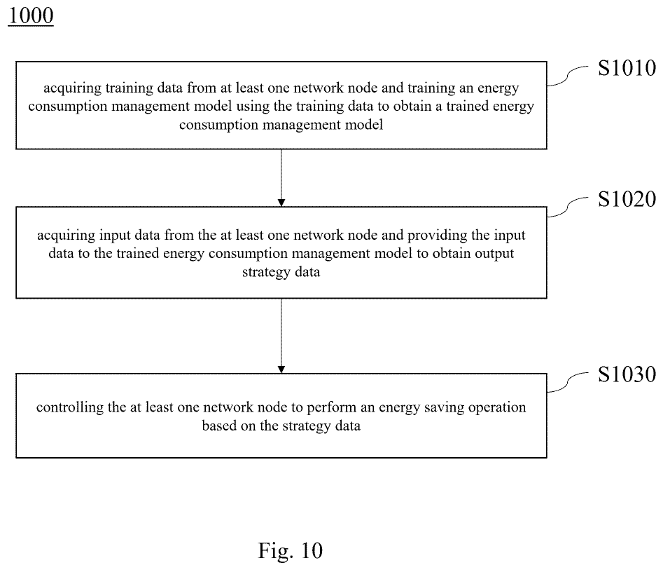

The present disclosure further provides a network energy consumption management method. FIG. 10 shows an example flow diagram of a network energy consumption management method 1000 in accordance with an embodiment of the principles of the present disclosure.

As shown in FIG. 10, the network energy consumption management method 1000 includes:
S1010: acquiring training data from at least one network node and training an energy consumption management model using the training data to obtain a trained energy consumption management model;
S1020: acquiring input data from the at least one network node and providing the input data to the trained energy consumption management model to obtain output strategy data; and
S1030: controlling the at least one network node to perform an energy saving operation based on the strategy data.

The above steps S1010-S1030 correspond to each of the functions described above with respect to the training unit, the prediction unit, and the execution unit, respectively, and other additional functions or processes described above with respect to the training unit, the prediction unit, and the execution unit may also be considered as additional or sub steps of each of the above steps of the method 1000, unless otherwise stated in the text or unless it is apparent not applicable from the context. applicable, they will not be repeated herein.

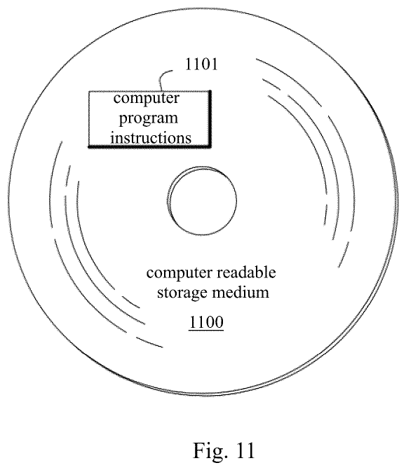

The present disclosure also provides a non-transitory computer readable storage medium. FIG. 11 illustrates a schematic diagram of a computer-readable storage medium 1100 according to an embodiment of the principles of the present disclosure. Wherein, the computer-readable storage medium 1100 has computer program instructions 1101 stored thereon, wherein the computer program instructions 1101, when executed by a processor, will execute a network energy consumption management method provided by embodiments of the present disclosure.

The present invention has been described based on embodiments in the foregoing description. The embodiments are illustrative only, and it should be understood by those skilled in the art that combinations of the constituent elements and processes of the embodiments may be modified in various ways, and that such modifications are within the scope of the present invention.

1. A network energy consumption management system, comprising:
a training unit configured to acquire training data from at least one network node and train an energy consumption management model using the training data to obtain a trained energy consumption management model;
a prediction unit configured to obtain input data from the at least one network node and provide the input data to the trained energy consumption management model to obtain output strategy data; and
an execution unit configured to control the at least one network node to perform an energy saving operation based on the strategy data,
wherein the energy consumption management model comprises:
a status prediction module configured to predict one or more of: user location information, traffic load and energy consumption of the at least one network node based on the input data; and
an energy saving strategy module configured to make an energy saving strategy based on the predicted user location information, the predicted traffic load, the predicted energy consumption of the at least one network node, and a current status of a target network node to be subjected to energy consumption management.

2. The system of claim 1, further comprising:
an administrative unit configured to maintain and manage the at least one network node, and
wherein the target network node of the at least one network node subjected to energy consumption management comprises a central unit and a distribution unit.

3. The system of claim 2, wherein the training unit and the prediction unit are arranged in the administrative unit.

4. The system of claim 2, wherein the training unit is arranged in the administrative unit and the prediction unit is arranged in a central unit of the target network node.

5. The system of claim 2, wherein the training unit and the prediction unit are arranged in a central unit of the target network node.

6. The system of claim 3, wherein
the training unit sends a training data request to the at least one network node via a first interface between the administrative unit and the at least one network node,
the at least one network node sends the training data to the training unit via the first interface in response to the training data request.

7. The system of claim 5, wherein,
the training unit sends a training data request to another network node via a second interface between the target network node and the other network node,
the other network node sends the training data to the training unit via the second interface in response to the training data request.

8. The system of claim 3, wherein,
the prediction unit sends an input data request to the at least one network node via a first interface between the administrative unit and the at least one network node,
the at least one network node sends the input data to the prediction unit via the first interface in response to the input data request.

9. The system of claim 4, wherein
the prediction unit sends an input data request to another network node via a second interface between the target network node and the other network node,
the other network node sends the training data to the prediction unit via the second interface in response to the input data request.

10. The system of claim 4, wherein,
the prediction unit further sends an energy consumption management model request to the administrative unit via a first interface between the administrative unit and the target network node,
the administrative unit sends the trained energy consumption management model to the prediction unit via the first interface in response to the energy consumption management model request.

11. The system of claim 3, wherein, upon receiving the strategy data, the prediction unit sends the strategy data to the target network node via a first interface between the administrative unit and the target network node.

12. A network energy consumption management method, comprising:
acquiring training data from at least one network node and training an energy consumption management model using the training data to obtain a trained energy consumption management model;
obtaining input data from the at least one network node and providing the input data to the trained energy consumption management model to obtain output strategy data; and
controlling the at least one network node to perform an energy saving operation based on the strategy data,
wherein the energy consumption management model is adapted to perform the following operations:
predicting one or more of: user location information, traffic load and energy consumption of the at least one network node based on the input data; and
making an energy saving strategy based on the predicted user location information, the predicted traffic load, the predicted energy consumption of the at least one network node, and a current status of a target network node to be subjected to energy consumption management.

13. A non-transitory computer-readable storage medium having instructions stored thereon, when executed by a processor, the instructions cause the processor to:
acquire training data from at least one network node and training an energy consumption management model using the training data to obtain a trained energy consumption management model;
obtain input data from the at least one network node and providing the input data to the trained energy consumption management model to obtain output strategy data; and
control the at least one network node to perform an energy saving operation based on the strategy data,
wherein the energy consumption management model is adapted to perform the following operations;
predicting one or more of: user location information, traffic load and energy consumption of the at least one network node based on the input data; and
making an energy saving strategy based on the predicted user location information, the predicted traffic load, the predicted energy consumption of the at least one network node, and a current status of a target network node to be subjected to energy consumption management.
